(19) United States
(12) Patent Application Publication
(10) Pub. No.: US 2026/0112646 A1
(43) Pub. Date: Apr. 23, 2026

(54) POSITIVE ELECTRODE PLATE FOR NON-AQUEOUS ELECTROLYTE SECONDARY BATTERY, PRODUCTION METHOD, AND NON-AQUEOUS ELECTROLYTE SECONDARY BATTERY

(71) Applicants: Prime Planet Energy & Solutions, Inc., Tokyo (JP); Nissan Chemical Corporation, Tokyo (JP)

(72) Inventors: Hayaki MATSUMOTO, Kobe-shi (JP); Tatsuya HATANAKA, Funabashi-shi (JP); Takumi IKEDA, Funabashi-shi (JP)

(21) Appl. No.: 19/354,847

(22) Filed: Oct. 10, 2025

(30) Foreign Application Priority Data
Oct. 18, 2024 (JP) 2024-184037

(51) Int. Cl. H01M 4/62; H01M 4/02; H01M 4/131; H01M 4/1391; H01M 4/525; H01M 4/66; H01M 10/0525; H01M 10/42

(52) U.S. Cl. CPC H01M 4/628; H01M 4/131; H01M 4/1391; H01M 4/525; H01M 4/661; H01M 10/0525; H01M 10/4235; H01M 2004/028

(57) ABSTRACT

The present disclosure relates to a positive electrode plate including a positive electrode composite material layer including a positive electrode active material and at least one type of heterocyclic-ring-containing compound; the positive electrode active material is a lithium-(transition metal) composite oxide that contains lithium and nickel; a content of nickel in the lithium-(transition metal) composite oxide is 70 mol % or more relative to a total number of moles of metallic element except lithium; a pH of the positive electrode active material in a state of a filtrate obtained by adding 25 g of the positive electrode active material to 50 g of pure water followed by stirring for 5 minutes and filtration is from 11.8 to 12.5; and a content of the heterocyclic-ring-containing compound in the positive electrode composite material layer is from 0.01 to 0.5 mass % relative to a mass of the positive electrode composite material layer.

### CROSS REFERENCE TO RELATED APPLICATIONS

This nonprovisional application is based on Japanese Patent Application No. 2024-184037 filed on Oct. 18, 2024, with the Japan Patent Office, the entire contents of which are hereby incorporated by reference.

### BACKGROUND OF THE INVENTION

### Field of the Invention

The present disclosure relates to a positive electrode plate for a non-aqueous electrolyte secondary battery, and it also relates to a method of producing the same and a non-aqueous electrolyte secondary battery.

### Description of the Background Art

Japanese Patent Laying-Open No. 2011-113825 suggests a positive electrode material for a lithium-ion secondary battery, wherein the positive electrode material includes a positive electrode active material with a high nickel content.

### SUMMARY OF THE INVENTION

When a positive electrode plate including a positive electrode active material with a high nickel content is used in a lithium-ion secondary battery, capacity can be enhanced but output resistance tends to increase.

An object of the present disclosure is to provide a positive electrode plate that makes it possible to inhibit an increase of output resistance and also inhibit a decrease of charged capacity, a method of producing the same, as well as a non-aqueous electrolyte secondary battery including the positive electrode plate.
[1] A positive electrode plate for a non-aqueous electrolyte secondary battery, the positive electrode plate comprising:
a positive electrode composite material layer; and
a positive electrode current collector, wherein
the positive electrode current collector contains aluminum,
the positive electrode composite material layer includes a positive electrode active material and at least one type of heterocyclic-ring-containing compound represented by a formula (1) below:

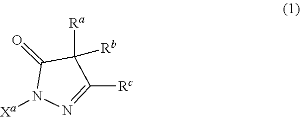

where
R^{a} to R^{c} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group, or
a formula (2) below:

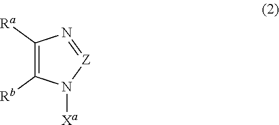

where
R^{a} and R^{b} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group;
R^{a} and R^{b} are optionally bonded together to form an optionally-substituted C₄₋₁₂ ring;
Z is N or C—R^{d};
R^{d} is a hydrogen atom, a halogen atom, a carboxy group, a hydroxy group, a thiol group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group,
the positive electrode active material is a lithium-(transition metal) composite oxide that contains lithium and nickel,
a content of nickel in the lithium-(transition metal) composite oxide is 70 mol % or more relative to a total number of moles of metallic element except lithium,
a pH of the positive electrode active material in a state of a filtrate obtained by adding 25 g of the positive electrode active material to 50 g of pure water followed by stirring for 5 minutes and filtration is from 11.8 to 12.5, and
a content of the heterocyclic-ring-containing compound in the positive electrode composite material layer is from 0.01 to 0.5 mass % relative to a mass of the positive electrode composite material layer.
[2] The positive electrode plate for a non-aqueous electrolyte secondary battery according to [1], wherein the positive electrode active material includes a first active material having an average particle size D50 from 2 to 6 μm.
[3] The positive electrode plate for a non-aqueous electrolyte secondary battery according to [2], wherein the first active material is in a form of single particles, or in a form of secondary particles each consisting of 2 to 10 primary particles aggregated together.
[4] The positive electrode plate for a non-aqueous electrolyte secondary battery according to [2] or [3], wherein the first active material has a BET specific surface area from 0.2 to 1.5 m²/g.
[5] The positive electrode plate for a non-aqueous electrolyte secondary battery according to any one of [1] to [4], wherein the positive electrode active material includes a second active material having an average particle size D50 from 10 to 20 μm.
[6] The positive electrode plate for a non-aqueous electrolyte secondary battery according to [5], wherein the second active material is in a form of secondary particles each consisting of 50 or more primary particles aggregated together.
[7] The positive electrode plate for a non-aqueous electrolyte secondary battery according to [5] or [6], wherein the second active material has a BET specific surface area from 0.2 to 1.0 m²/g.
[8] A method of producing a positive electrode plate for a non-aqueous electrolyte secondary battery, wherein
the method is a method of producing the positive electrode plate for a non-aqueous electrolyte secondary battery according to any one of [1] to [7], and
the method includes a slurry preparation step that involves mixing the positive electrode active material and the heterocyclic-ring-containing compound together to obtain a positive electrode composite material slurry.
[9] The method of producing a positive electrode plate for a non-aqueous electrolyte secondary battery according to [8], wherein the slurry preparation step includes:
a first step to mix the positive electrode active material, a binder, and a dispersion medium to obtain a first mixture; and
a second step to mix the first mixture and the heterocyclic-ring-containing compound to obtain a second mixture.
[10] The method of producing a positive electrode plate for a non-aqueous electrolyte secondary battery according to [8], wherein the positive electrode active material and the heterocyclic-ring-containing compound are mixed so that a content of the heterocyclic-ring-containing compound relative to a solid matter in the positive electrode composite material slurry becomes 0.01 to 0.5 mass %.
[11] A non-aqueous electrolyte secondary battery comprising the positive electrode plate for a non-aqueous electrolyte secondary battery according to any one of [1] to [7].

The foregoing and other objects, features, aspects and advantages of the present invention will become more apparent from the following detailed description of the present disclosure when taken in conjunction with the accompanying drawings.

### BRIEF DESCRIPTION OF THE DRAWINGS

FIG. 1 is a schematic view illustrating an example of the layered configuration of a positive electrode plate.

FIG. 2 is a schematic flowchart illustrating a method of producing a positive electrode plate according to the present embodiment.

FIG. 3 is a schematic view illustrating an example configuration of a battery according to the present embodiment.

FIG. 4 is a schematic view illustrating an example configuration of an electrode assembly according to the present embodiment.

### DESCRIPTION OF THE PREFERRED EMBODIMENTS

### <Positive Electrode Plate for Non-Aqueous Electrolyte Secondary Battery>

A positive electrode plate for a non-aqueous electrolyte secondary battery according to the present disclosure (hereinafter also called a positive electrode plate) includes a positive electrode composite material layer and a positive electrode current collector; the positive electrode current collector contains aluminum (Al); the positive electrode composite material layer includes a positive electrode active material and at least one type of heterocyclic-ring-containing compound represented by a formula (1) or a formula (2) (hereinafter also called a heterocyclic-ring-containing compound); the positive electrode active material is a lithium-(transition metal) composite oxide that contains lithium (Li) and nickel (Ni); the content of Ni in the lithium-(transition metal) composite oxide (hereinafter also called the Ni content) is 70 mol % or more relative to the total number of moles of metallic elements except Li; a pH (hereinafter also called a first pH) of the positive electrode active material in a state of a filtrate obtained by adding 25 g of the positive electrode active material to 50 g of pure water followed by stirring for 5 minutes and filtration is from 11.8 to 12.5; and the content of the heterocyclic-ring-containing compound in the positive electrode composite material layer is from 0.01 to 0.5 mass % relative to the mass of the positive electrode composite material layer.

The present disclosure makes it possible to inhibit an increase of output resistance of a non-aqueous electrolyte secondary battery (hereinafter also called a battery) and also inhibit a decrease of charged capacity. According to the findings of the inventors of the present invention, an increase of output resistance that can occur when a positive electrode plate including a positive electrode active material with a high Ni content is used is caused by corrosion of Al that occurs at the interface between the positive electrode active material and an Al-containing positive electrode current collector. In this regard, it has been found that the positive electrode active material with a high Ni content has a high alkali content and therefore an alkaline component tends to be released from the positive electrode active material, and, as a result, when the positive electrode active material comes into contact with the Al-containing positive electrode current collector, an alkaline component thus released causes corrosion of the Al-containing positive electrode current collector at the interface. In the case of the positive electrode plate according to the present disclosure, a positive electrode active material with a high Ni content is used and, thereby, a decrease of charged capacity can be inhibited; and, also, the heterocyclic-ring-containing compound adsorbs on both the surface of the positive electrode active material as well as on the surface of the Al-containing positive electrode current collector to inhibit direct contact between the positive electrode active material and the Al-containing positive electrode current collector, while the first pH of the positive electrode active material is set to fall within the above-mentioned range to inhibit a decrease of charged capacity and also inhibit corrosion of the positive electrode current collector which can occur due to alkaline components, and thereby an increase of output resistance can be inhibited.

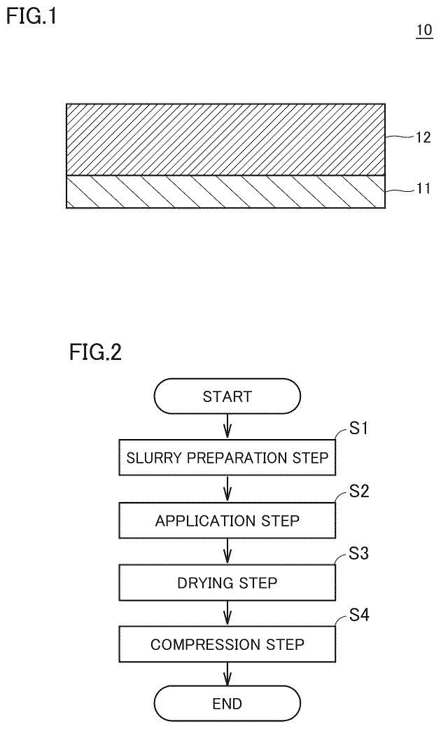

The positive electrode plate for a non-aqueous electrolyte secondary battery according to the present disclosure (hereinafter also called the positive electrode plate) will be described referring to FIG. 1. A positive electrode plate 10 includes a positive electrode composite material layer 12 and a positive electrode current collector 11. Positive electrode composite material layer 12 may be placed on the surface of positive electrode current collector 11. As illustrated in FIG. 1, positive electrode composite material layer 12 may be placed on only one side of positive electrode current collector 11. Positive electrode composite material layer 12 may be placed on both sides of positive electrode current collector 11.

Positive electrode current collector 11 is a conductive sheet. Positive electrode current collector 11 contains Al. Positive electrode current collector 11 may be a pure Al foil sheet or an Al alloy foil sheet. Positive electrode current collector 11 may have a thickness from 10 to 30 μm, for example. The thickness of positive electrode plate 10 may be from 20 to 290 μm, or from 50 to 250 μm, or from 100 to 200 μm, for example. The dimension of positive electrode plate 10 in the longitudinal direction may be from 0.5 to 5 m, or from 1 to 3 m, for example. At an end of positive electrode plate 10 in a direction parallel to the longitudinal direction, positive electrode current collector 11 may be exposed. To the exposed portion of positive electrode current collector 11, a positive electrode current-collecting member described below may be joined.

Positive electrode composite material layer 12 includes a positive electrode active material. The positive electrode active material is a lithium-(transition metal) composite oxide that contains Li and Ni. The lithium-(transition metal) composite oxide includes at least one selected from the group consisting of LiCoO₂, LiNiO₂, LiMnO₂, LiMn₂O₄, Li(NiCoMn)O₂, Li(NiCoAl)O₂, and LiFePO₄, for example. In a composition formula such as “Li(NiCoMn)O₂”, for example, the constituents within the parentheses are collectively regarded as a single unit in the entire composition ratio. That is, the relationship of “C_{Ni}+C_{Co}+C_{Mn}=1” is satisfied. For example, “C_{Ni}” refers to the composition ratio of Ni. As long as (NiCoMn) is collectively regarded as a single unit in the entire composition ratio, the amounts of the individual constituents are not particularly limited. Positive electrode composite material layer 12 can include positive electrode active material particles. The positive electrode active material particles may include a freely-selected component. The positive electrode active material particles may include the above-described lithium-(transition metal) composite oxide.

The Ni content of the lithium-(transition metal) composite oxide relative to the total number of moles of metallic elements except Li is 70 mol % or more, and from the viewpoint of packing capacity, it is preferably 80 mol % or more, more preferably 90 mol % or more. When the Ni content of the lithium-(transition metal) composite oxide falls within the above-mentioned range, charged capacity of the battery tends to be enhanced.

For example, the lithium-(transition metal) composite oxide may include one, two, or more types of first layered metal oxide represented by a formula (i) below:

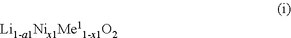

[where
“a1” satisfies the relationship of −0.3≤a1≤0.3;
“x1” satisfies the relationship of 0.70≤x1≤1.0; and
“Me¹” represents at least one selected from the group consisting of cobalt (Co), manganese (Mn), Al, titanium (Ti), zirconium (Zr), boron (B), magnesium (Mg), iron (Fe), copper (Cu), zinc (Zn), tin (Sn), sodium (Na), potassium (K), barium (Ba), strontium (Sr), calcium (Ca), tungsten (W), molybdenum (Mo), niobium (Nb), silicon (Si), vanadium (V), chromium (Cr), and germanium (Ge)].

Preferably, the lithium-(transition metal) composite oxide is lithium-nickel-cobalt-manganese composite oxide. The lithium-(transition metal) composite oxide may include at least one selected from the group consisting of LiNi_{0.82}Co_{0.13}Mn_{0.05}O₂ and LiNi_{0.92}Co_{0.04}Mn_{0.04}O₂, for example. The lithium-(transition metal) composite oxide may be essentially made of at least one selected from the group consisting of LiNi_{0.82}Co_{0.13}Mn_{0.05}O₂ and LiNi_{0.92}Co_{0.04}Mn_{0.04}O₂, for example.

The lithium-nickel-cobalt-manganese composite oxide is prepared by the procedure described below, for example. Firstly, a lithium source such as lithium hydroxide and a nickel-cobalt-manganese composite hydroxide are mixed together and calcined, followed by wet grinding in a ball mill and/or the like and drying. Then, the resultant is rinsed with pure water and dried, and thereby the above-mentioned lithium-nickel-cobalt-manganese composite oxide can be obtained. The nickel-cobalt-manganese composite hydroxide may be obtained by coprecipitation and/or the like, for example. The nickel-cobalt-manganese composite hydroxide may be a compound represented by the general formula NiₓCo_{y}Mn_{z} (OH)₂ (where x+y+z=1), for example. Rinsing with pure water can be carried out by, for example, adding the lithium-nickel-cobalt-manganese composite oxide and pure water in a vessel and stirring. The mass ratio (solid-liquid ratio) between the lithium-nickel-cobalt-manganese composite oxide and pure water may be, for example, from 30 to 50 mass % relative to the total mass of the lithium-nickel-cobalt-manganese composite oxide and the pure water. The duration of rinsing may be from 1 minute to 60 minutes, for example.

The first pH of the positive electrode active material is from 11.8 to 12.5. The first pH is the pH of filtrate that is obtained by adding 25 g of the positive electrode active material to 50 g of pure water followed by stirring for 5 minutes and filtration. When the first pH of the positive electrode active material is less than 11.8, the content of alkaline components in the positive electrode active material is low, and charged capacity tends not to be enhanced. When the first pH of the positive electrode active material is more than 12.5, the content of alkaline components in the positive electrode active material is high and corrosion of the positive electrode current collector tends to occur, and thereby an increase of output resistance tends not to be inhibited. When the positive electrode active material includes two or more types of positive electrode active materials, the first pH of the positive electrode active material as a whole falls within the above-mentioned range. The first pH of the positive electrode active material can be controlled by adjusting the conditions for rinsing the positive electrode active material with water (such as, for example, the solid-liquid ratio and the duration of rinsing), for example.

The positive electrode active material can include a first active material having an average particle size D50 from 2 to 6 μm or a second active material having an average particle size D50 from 10 to 20 μm. The positive electrode active material may be the first active material or the second active material. The average particle size D50 of the first active material may be smaller than that of the second active material. In the present specification, the average particle size D50 refers to a particle size in volume-based particle size distribution at which the cumulative particle volume accumulated from the side of small particle sizes reaches 50% of the total particle volume. The average particle size may be measured by a laser diffraction and scattering method.

The first active material may be in the form of single particles, or in the form of secondary particles each consisting of 2 to 10 primary particles aggregated together. When the first active material is in the form of secondary particles, the number of primary particles aggregated together to form each secondary particle may be from 2 to 8, or from 2 to 5.

When the first active material is in the form of single particles, or in the form of secondary particles each consisting of 2 to 10 primary particles aggregated together, the average particle size R1 of the single particles and the primary particles may be 0.5 μm or more, or 1.0 μm or more, or 1.5 μm or more, or 1.7 μm or more, or from 1.7 to 6 μm, or from 2 to 5 μm, or from 2.5 to 4.5 μm, for example. The average particle size R1 is a value determined in an image of the surface of the first active material examined with an SEM, and it is obtained by firstly performing image analysis of an SEM image of the surfaces of the first active material particles to determine the longest diameters of respective single particles or respective primary particles and then averaging the resulting values for the single particles or the primary particles.

The first pH of the first active material may be from 11.8 to 12.5.

The BET specific surface area of the first active material may be from 0.2 to 1.5 m²/g, for example.

The average particle size D50 of the second active material may be from 10 to 20 μm, for example, and it is preferably from 12 to 20 μm, more preferably from 13 to 19 μm, further preferably from 14 to 18 μm.

The second active material may be in the form of secondary particles (hereinafter also called aggregate particles) each consisting of 50 or more primary particles aggregated together. In the second active material, the number of primary particles aggregated together may be 100 or more, or may be 1000 or more, or may be 10000 or more; and it is usually 5×10⁶ or less, and it may be 5×10⁵ or less.

When the second active material is in the form of aggregate particles, the average particle size R2 of the primary particles constituting the aggregate particles is 2.0 μm or less, and it may be, for example, 0.1 μm or more, or from 0.5 to 1.7 μm, or from 0.7 to 1.5 μm. The average particle size R2 is a value determined in an image of the surface of the second active material examined with a scanning electron microscope (SEM), and it is obtained by firstly performing image analysis of an SEM image of the surfaces of the second active material particles to determine the longest diameters of respective primary particles and then averaging the resulting values for the second active material particles.

The first pH of the second active material may be from 11.8 to 12.5.

The BET specific surface area of the second active material may be from 0.2 to 1.0 m²/g, for example.

Preferably, from the viewpoint of packing properties, the positive electrode active material includes the first active material and the second active material. When the positive electrode active material includes the first active material and the second active material, the content of the second active material relative to the total mass (defined as 100 mass %) of the positive electrode active material may be, for example, from 10 to 90 mass %, or from 25 to 85 mass %, and from the viewpoint of the packing density of the positive electrode composite material layer, it is preferably from 40 to 80 mass %.

Generally, when a positive electrode active material includes a first active material, as compared to when the positive electrode active material includes a second active material, corrosion of a positive electrode current collector tends to occur. This is because a positive electrode active material like the first active material which has a high Ni content and a relatively small average particle size D50 has the following issues: (1) the structure is relatively unstable, and more alkalis elute; (2) due to its relatively small average particle size D50, the area of contact with an Al-containing positive electrode current collector is relatively large; and (3) the first active material has a relatively low density, and, therefore, in order to form a positive electrode composite material layer that has an equivalent density to a positive electrode composite material layer including a second active material, it is required to apply a relatively strong force for compression during the production of the positive electrode plate. However, according to the present disclosure, even then the positive electrode active material includes the first active material, corrosion of the positive electrode current collector can be inhibited and an increase of output resistance tends to be inhibited.

The heterocyclic-ring-containing compound used in the present disclosure is represented by either a formula (1):

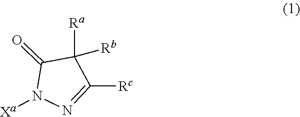

[where
R^{a} to R^{c} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group]; or
a formula (2):

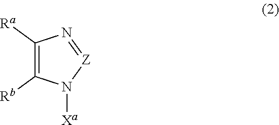

[where
R^{a} and R^{b} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group;
R^{a} and R^{b} are optionally bonded together to form an optionally-substituted C₄₋₁₂ ring;
Z is N or C—R^{d};
R^{d} is a hydrogen atom, a halogen atom, a carboxy group, a hydroxy group, a thiol group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group].

The heterocyclic-ring-containing compound represented by the formula (1) may be a structural isomer. Specific examples of a structural isomer of the heterocyclic-ring-containing compound represented by the formula (1) include heterocyclic-ring-containing compounds represented by formulae (1-A) to (1-G) below:

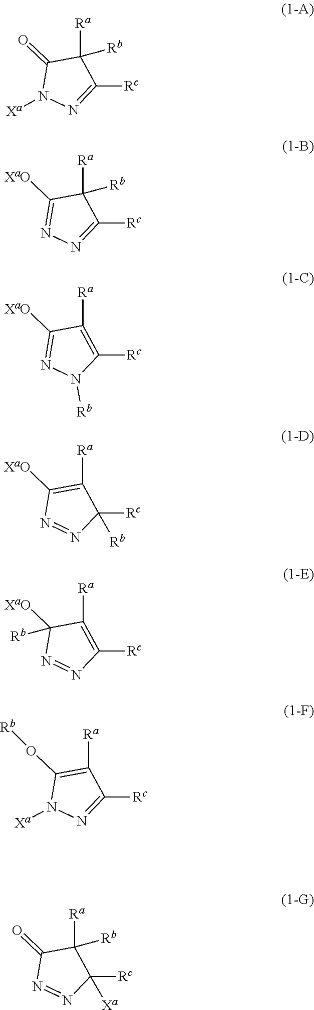

[where R^{a} to R^{c} and X^{a} are as defined above].

When X^{a} is a hydrogen atom, a tautomer is preferable among the above-mentioned structural isomers. When X^{a} is a hydrogen atom, the tautomer is also called a proton tautomer.

The C₁₋₆ alkyl group of the “optionally-substituted C₁₋₆ alkyl group” as R^{a} to R^{c} may be linear, branched, or cyclic, and specific examples thereof include linear or branched C₁₋₆ alkyl groups such as methyl group, ethyl group, n-propyl group, isopropyl group, n-butyl group, isobutyl group, s-butyl group, t-butyl group, n-pentyl group, and n-hexyl group; and C₃₋₆ cyclic alkyl groups such as cyclopropyl group, cyclobutyl group, cyclopentyl group, and cyclohexyl group.

Examples of the C₂₋₆ alkenyl group of the “optionally-substituted C₂₋₆ alkenyl group” as R^{a} to R^{c} include ethenyl group, n-1-propenyl group, n-2-propenyl group, 1-methylethenyl group, n-1-butenyl group, n-2-butenyl group, n-3-butenyl group, 2-methyl-1-propenyl group, 2-methyl-2-propenyl group, 1-ethylethenyl group, 1-methyl-1-propenyl group, 1-methyl-2-propenyl group, n-1-pentenyl group, and the like.

Examples of the C₆₋₁₂ aryl group of the “optionally-substituted C₆₋₁₂ aryl group” as R^{a} to R^{c} include phenyl group, tolyl group, 1-naphthyl group, 2-naphthyl group, and the like.

R^{a} to R^{c} may have a substituent. Examples of the substituent include a carboxy group, a hydroxy group, an aldehyde group, an ester group, a ketone group, an amino group, a phenyl group, a halogen atom, an alkoxysilyl group, an epoxy group, a carboxylic acid chloride group, a thiol group, and the like. Examples of the alkoxysilyl group include trimethoxysilyl group, dimethoxymethylsilyl group, methoxydimethylsilyl group, triethoxysilyl group, diethoxymethylsilyl group, ethoxydimethylsilyl group, and the like. In the present disclosure, a carboxy group is preferable. When R^{a} to R^{c} have a substituent, the number thereof is preferably from 1 to 6, more preferably from 1 to 3.

Preferably, each of R^{a} to R^{c} is a hydrogen atom, a carboxy group, an optionally-substituted C₁₋₆ alkyl group, or an optionally-substituted C₆₋₁₂ aryl group, and preferably, R^{a} and R^{b} in the formula (2) are bonded together to form an optionally-substituted C₄₋₁₂ ring.

More preferably, each of R^{a} to R^{c} is a hydrogen atom, a carboxy group, a C₁₋₆ alkyl group, or a C₆₋₁₂ aryl group, and more preferably, R^{a} and R^{b} in the formula (2) are bonded together to form an optionally-substituted C₄₋₁₂ ring.

Even more preferably, each of R^{a} to R^{c} is a hydrogen atom, a carboxy group, a C₁₋₃ alkyl group, or a C₆₋₁₀ aryl group, and even more preferably, R^{a} and R^{b} in the formula (2) are bonded together to form an optionally-substituted C₆₋₁₀ ring.

Further preferably, each of R^{a} to R^{c} is a hydrogen atom, a carboxy group, a methyl group, or a phenyl group, and further preferably, R^{a} and R^{b} in the formula (2) are bonded together to form an optionally-substituted benzene ring.

Z is N or C—R^{d}, and R^{d} is a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group.

As Z, N is preferable.

The C₁₋₆ alkyl group of the “optionally-substituted C₁₋₆ alkyl group” as X^{a} may be linear, branched, or cyclic, and specific examples thereof include linear or branched C₁₋₆ alkyl groups such as methyl group, ethyl group, n-propyl group, isopropyl group, n-butyl group, isobutyl group, s-butyl group, t-butyl group, n-pentyl group, and n-hexyl group; and C₃₋₆ cyclic alkyl groups such as cyclopropyl group, cyclobutyl group, cyclopentyl group, and cyclohexyl group.

Examples of the C₆₋₁₂ aryl group of the “optionally-substituted C₆₋₁₂ aryl group” as X^{a} include phenyl group, tolyl group, 1-naphthyl group, 2-naphthyl group, and the like.

X^{a} may have a substituent. Examples of the substituent include a carboxy group, a hydroxy group, an aldehyde group, an ester group, a ketone group, an amino group, a phenyl group, a halogen atom, an alkoxysilyl group, an epoxy group, a carboxylic acid chloride group, a thiol group, and the like. Examples of the alkoxysilyl group include trimethoxysilyl group, dimethoxymethylsilyl group, methoxydimethylsilyl group, triethoxysilyl group, diethoxymethylsilyl group, ethoxydimethylsilyl group, and the like. In the present invention, a carboxy group and an alkoxysilyl group are preferable, and a carboxy group and a trimethoxysilyl group are more preferable.

Preferably, X^{a} is a hydrogen atom, an optionally-substituted C₁₋₆ alkyl group, and an optionally-substituted C₆₋₁₂ aryl group.

More preferably, X^{a} is a hydrogen atom, a C₁₋₄ alkyl group, and a C₆₋₁₀ aryl group.

Even more preferably, X^{a} is a hydrogen atom, a C₁₋₃ alkyl group, and a C₆₋₈ aryl group.

Specific examples of the heterocyclic-ring-containing compound represented by the formula (1) include heterocyclic-ring-containing compounds represented by formulae (1-1) to (1-14) below.

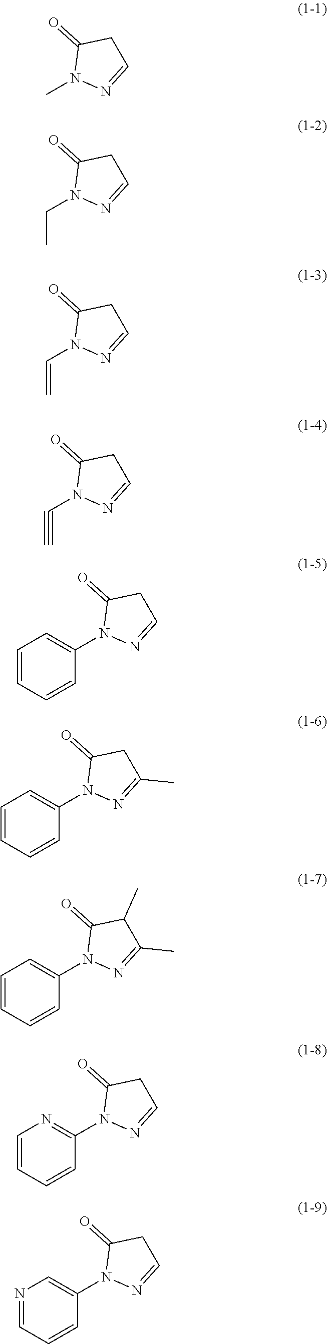

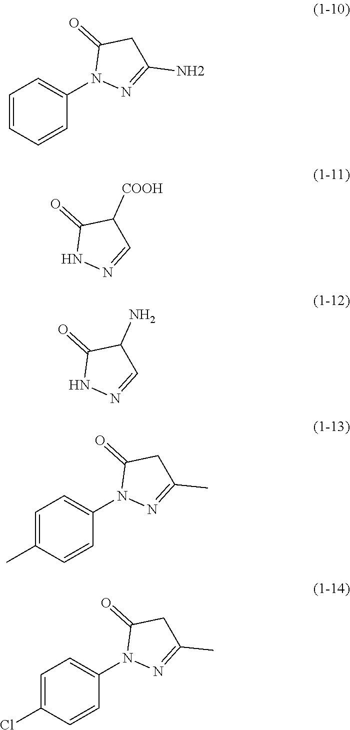

Specific examples of the heterocyclic-ring-containing compound represented by the formula (2) include heterocyclic-ring-containing compounds represented by formulae (2-1) to (2-13) below.

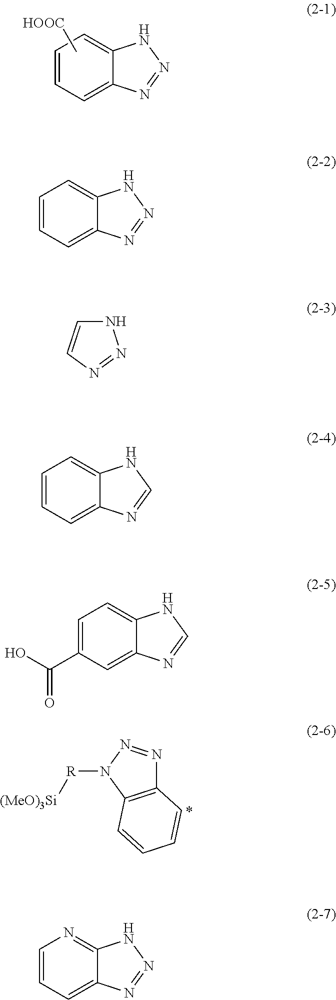

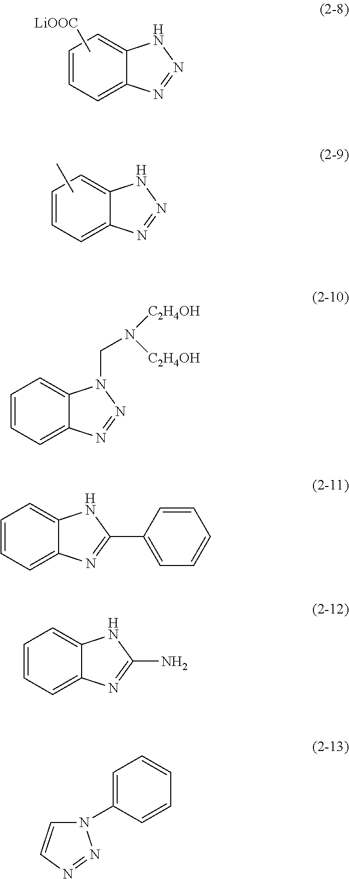

*The structure of the heterocyclic-ring-containing compound represented by the formula (2-6) is the structure of X-12-1214A manufactured by Shin-Etsu Chemical Co., Ltd., a compound found in a catalog available from the company.

As the heterocyclic-ring-containing compound represented by the formula (1) or the formula (2), a commercially available product can be used, for example. Examples of a commercially available product of the heterocyclic-ring-containing compound represented by the formula (1) or the formula (2) include SA-426H (manufactured by Nissan Chemical Corporation), X-12-1214A (manufactured by Shin-Etsu Chemical Co., Ltd.), and the like.

The content of the heterocyclic-ring-containing compound in positive electrode composite material layer 12 relative to the mass of positive electrode composite material layer 12 is from 0.01 to 0.5 mass %. When the content of the heterocyclic-ring-containing compound in the positive electrode composite material layer falls within the above-mentioned range, the positive electrode active material is uniformly covered with the heterocyclic-ring-containing compound, and, thereby, alkali elution from the positive electrode active material tends to be inhibited and a decrease of charged capacity tends not to occur. When the content of the heterocyclic-ring-containing compound in the positive electrode composite material layer is less than 0.01 mass %, corrosion of the positive electrode current collector tends not to be inhibited and an increase of output resistance tends not to be inhibited. When the content of the heterocyclic-ring-containing compound in the positive electrode composite material layer is more than 0.5 mass %, charged capacity tends not to be enhanced. Moreover, when an additive other than the above-mentioned heterocyclic-ring-containing compound is used, the amount of the additive to be added needs to be greater than the content of the heterocyclic-ring-containing compound in order to obtain the inhibitory effect to inhibit alkali elution and associated corrosion of the positive electrode current collector, but on the other hand, due to the great amount, output properties are negatively affected and, thereby, the output inhibitory effect may not be obtained. From the viewpoint of output resistance and charged capacity, the content of the heterocyclic-ring-containing compound in positive electrode composite material layer 12 relative to the mass of positive electrode composite material layer 12 is preferably from 0.0125 to 0.3 mass %, more preferably from 0.025 to 0.2 mass %.

In addition to the positive electrode active material and the heterocyclic-ring-containing compound, positive electrode composite material layer 12 may include a binder, a conductive material, and the like. The binder may be a known material, such as, for example, a fluororesin such as polyvinylidene difluoride (PVDF) and polytetrafluoroethylene (PTFE) and/or a cellulose-based resin such as carboxymethylcellulose (CMC). The conductive material may be a carbon material, for example. The carbon material may be one or more selected from the group consisting of fibrous carbon, carbon black, coke, and activated carbon, for example. The carbon black may be acetylene black (AB), for example.

The thickness of positive electrode composite material layer 12 refers to the total thickness of positive electrode composite material layers 12 included in a stack 40. For example, when positive electrode composite material layer 12 is formed on each side of positive electrode plate 10, the thickness of positive electrode composite material layer 12 refers to the total thickness of positive electrode composite material layers 12 on two sides. Positive electrode composite material layer 12 may have a thickness from 10 to 260 μm, or may have a thickness from 20 to 60 μm, or may have a thickness from 30 to 50 μm, for example. It should be noted that the thickness of positive electrode composite material layer 12 on one side may be from 10 to 30 μm, or may be from 15 to 25 μm, for example.

The density of positive electrode composite material layer 12 may be from 3.0 to 4.0 g/cm³, for example, and preferably, it is from 3.2 to 3.6 g/cm³.

### <Method of Producing Positive Electrode Plate>

Positive electrode plate 10 can be produced by, for example, applying a positive electrode composite material slurry to positive electrode current collector 11, drying, and compressing to form positive electrode composite material layer 12. As shown in FIG. 2, the method of producing positive electrode plate 10 includes a slurry preparation step (S1) to mix a positive electrode active material and a heterocyclic-ring-containing compound together to prepare a positive electrode composite material slurry. The method of producing a positive electrode plate can further include an application step (S2), a drying step (S3), and a compression step (S4).

In the slurry preparation step (S1), a positive electrode composite material slurry that includes a positive electrode active material and a heterocyclic-ring-containing compound is prepared. The positive electrode composite material slurry is prepared by dispersing the positive electrode active material and the heterocyclic-ring-containing compound in a dispersion medium. The dispersion medium may be an organic solvent, for example. The organic solvent may include at least one selected from the group consisting of N-methyl-2-pyrrolidone (NMP), tetrahydrofuran (THF), dimethylformamide (DMF), methyl ethyl ketone (MEK), and dimethyl sulfoxide (DMSO), for example. The amount of the organic solvent to be used is not particularly limited. The positive electrode composite material slurry may have a freely-selected solid concentration (mass fraction of solid matter). The positive electrode composite material may have a solid concentration from 40 to 80%, for example. For the mixing, a freely-selected stirring apparatus, a freely-selected mixing apparatus, and/or a freely-selected dispersing apparatus may be used. In the slurry preparation step (S1), the positive electrode active material and the heterocyclic-ring-containing compound may be mixed so that the content of the heterocyclic-ring-containing compound relative to the solid matter in the positive electrode composite material slurry becomes 0.01 to 0.5 mass %.

The slurry preparation step (S1) can include a first step to mix the positive electrode active material, a binder, and the dispersion medium to obtain a first mixture, and a second step to mix the first mixture and the heterocyclic-ring-containing compound to obtain a second mixture. In the case when the slurry preparation step (S1) includes the first step and the second step, by adding the heterocyclic-ring-containing compound after the dispersion medium is well distributed over the entire positive electrode active material, it is possible to avoid non-uniform dispersion of the heterocyclic-ring-containing compound that can occur due to adsorption of the heterocyclic-ring-containing compound onto the positive electrode active material.

In the first step, the positive electrode active material, the binder, and the dispersion medium can be mixed and kneaded at a rotational speed of 10 to 20 rpm so that the solid matter content becomes 85 to 95%, for example.

In the second step, the heterocyclic-ring-containing compound can be added together with the dispersion medium.

The second mixture obtained in the second step can be used as the positive electrode composite material slurry. In the case where the positive electrode composite material layer includes a conductive material, the conductive material can be added to the first mixture or the second mixture to prepare a positive electrode composite material slurry. The slurry preparation step (S1) can further include a conductive material addition step to add a conductive material to the first mixture or the second mixture. The conductive material addition step may be implemented after the first step and before the second step; in other words, the conductive material may be added to the first mixture after the first step and before the second step. Alternatively, the conductive material addition step may be implemented at the same time with the second step; in other words, the conductive material may be added in the second step together with the heterocyclic-ring-containing compound. Alternatively, the conductive material addition step may be implemented after the second step; in other words, the conductive material may be added to the second mixture. The conductive material can be added together with the dispersion medium.

In the conductive material addition step, the first mixture or the second mixture and the conductive material can be mixed and kneaded at a rotational speed of 20 to 40 rpm so that the solid matter content becomes 70 to 83%, for example.

In the application step (S2), the positive electrode composite material slurry is applied to the surface of a base material to form a coating film. For the application, a freely-selected application apparatus can be used.

In the drying step (S3), the coating film is heated and dried with a hot-air dryer and/or the like, for example, to form a dry coating film. The compression step (S4) may include compressing the dry coating film with a freely-selected compressing apparatus to form positive electrode composite material layer 12. The dried coating film is thus compressed, and thereby positive electrode composite material layer 12 is formed, and thus positive electrode plate 10 is completed. Positive electrode plate 10 may be cut into a certain planar size, according to the specifications of the battery. For example, positive electrode plate 10 may be cut into a belt-like planar shape. For example, positive electrode plate 10 may be cut into a rectangular planar shape.

### <Non-Aqueous Electrolyte Secondary Battery>

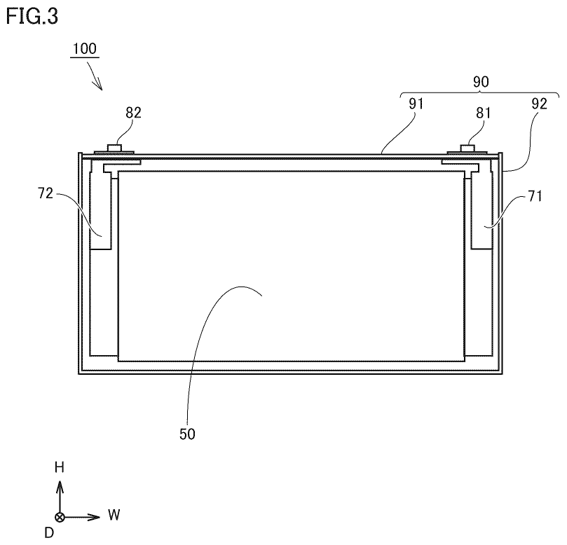

The non-aqueous electrolyte secondary battery according to the present disclosure (hereinafter also called the battery) can be a lithium-ion battery. FIG. 3 is a schematic view illustrating an example of the battery according to the present embodiment. A battery 100 illustrated in FIG. 3 may be, for example, a lithium-ion battery for use as a main electric power supply or a motive force assisting electric power supply of an electric vehicle. A plurality of batteries 100 may be connected together to form a battery module or a battery pack. Battery 100 may have a rated capacity from 1 to 200 Ah, for example.

Battery 100 includes an exterior package 90. Exterior package 90 may include a sealing plate 91 and an exterior container 92, for example. Sealing plate 91 closes the opening of exterior container 92. Sealing plate 91 and exterior container 92 may be joined together by laser processing and/or the like, for example. The configuration of exterior package 90 is not particularly limited. Exterior package 90 may be in the shape of a pouch, for example. More specifically, exterior package 90 may be a pouch made of an Al-laminated film, and/or the like.

Exterior package 90 accommodates an electrode assembly 50 and a non-aqueous electrolyte (not illustrated). To sealing plate 91, a positive electrode terminal 81 and a negative electrode terminal 82 are provided. To sealing plate 91, an inlet (not illustrated), a gas-discharge valve (not illustrated), and/or the like may be further provided. Through the inlet, the electrolyte solution may be injected into exterior package 90. The inlet may be closed with a plug and/or the like, for example.

A positive electrode current-collecting member 71 connects positive electrode terminal 81 with electrode assembly 50. Positive electrode current-collecting member 71 may be an Al plate and/or the like, for example. A negative electrode current-collecting member 72 connects negative electrode terminal 82 with electrode assembly 50. Negative electrode current-collecting member 72 may be a copper (Cu) plate and/or the like, for example.

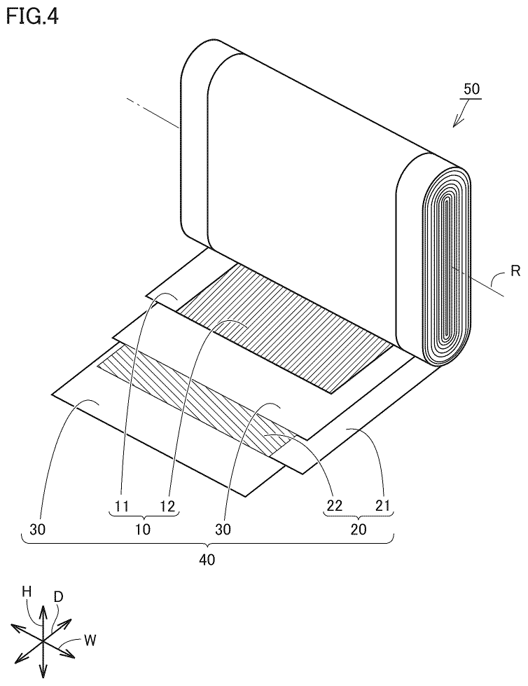

FIG. 4 is a schematic view illustrating an example of an electrode assembly according to the present embodiment. Electrode assembly 50 in FIG. 2 is a wound-type electrode assembly that has an axis of winding, R, parallel to the W-axis direction. Electrode assembly 50 includes positive electrode plate 10, a separator 30, and a negative electrode plate 20. That is, battery 100 includes positive electrode plate 10. Positive electrode plate 10 includes positive electrode composite material layer 12 and positive electrode current collector 11.

Usually, negative electrode plate 20 has a negative electrode current collector 21 and a negative electrode composite material layer 22 formed on one side or both sides of negative electrode current collector 21. Negative electrode current collector 21 is a metal foil sheet that is made of a copper material such as copper and copper alloy, for example. Negative electrode composite material layer 22 includes a negative electrode active material, and may further include a conductive material, a binder, and/or the like.

The negative electrode active material may be a known material, and examples thereof include carbon-based active material particles such as graphite, metal-based active material particles that include an element selected from the group consisting of Si, Sn, Sb, Bi, Ti, and Ge, and the like. Examples of the conductive material include those mentioned above. Examples of the binder include cellulose-based resins such as CMC, methylcellulose (MC), and hydroxypropylcellulose; polyacrylic acid; styrene-butadiene rubber (SBR); and the like. CMC may also be used as a thickener.

Separator 30 has a monolayered or multilayered base material, and on at least one side of the base material, it may have a functional layer. The base material may be a porous sheet such as a film and/or a nonwoven fabric, which is made of a resin such as polyolefin (such as polyethylene and polypropylene), polyester, cellulose, polyamide, and/or the like. The functional layer may be an adhesive layer and/or a heat-resistant layer, for example. The adhesive layer can be formed with an adhesive agent, for example. The heat-resistant layer can include a filler and a binder, for example.

The electrolyte solution is preferably obtained by adding an electrolyte to a non-aqueous solvent such as an organic solvent. Examples of the electrolyte include one or more from LiPF₆, LiBF₄, LiClO₄, LiFSO₃, LiB(C₂O₄)₂, and the like. Examples of the non-aqueous solvent include one or more from ethylene carbonate (EC), ethyl methyl carbonate (EMC), dimethyl carbonate (DMC), propylene carbonate (PC), butylene carbonate (BC), diethyl carbonate (DEC), and the like. The electrolyte solution may further include an additive such as vinylene carbonate (VC), vinylethylene carbonate (VEC), and/or fluoroethylene carbonate.

In the following, the present invention will be described in further detail by way of Examples.

### EXAMPLES

### [Positive Electrode Active Material]

Lithium-(transition metal) composite oxides with the Ni/Co/Mn molar ratios (also called the NCM ratios hereinafter), the average particle size D50, the BET specific surface area, and the first pH specified in Table 1 were prepared, and each of the lithium-(transition metal) composite oxides, together with pure water, was added to a vessel in the solid-liquid ratio specified in Table 1 and stirred for 10 minutes for rinsing, followed by filtration and drying at 120° C. for 5 hours, and thereby positive electrode active materials A to H were obtained. The solid-liquid ratio is the proportion (mass %) of the mass of the lithium-(transition metal) composite oxide to the total mass of the lithium-(transition metal) composite oxide and the pure water. In positive electrode active materials A to H, the molar ratio (Li:Me) between Li and metallic elements (Me) except Li was 1.05:1. Each of positive electrode active materials A to D, G, and H was in the form of single particles or secondary particles (a first active material) each consisting of 2 to 5 primary particles aggregated together. Each of positive electrode active materials E and F was in the form of secondary particles (a second active material) each consisting of 50 or more primary particles aggregated together. The BET specific surface area was measured with a specific surface area analyzer. As the first pH, the pH of filtrate that was obtained by adding 25 g of the rinsed positive electrode active material to 50 g of pure water followed by stirring for 5 minutes and filtration was measured.

TABLE 1

| Type of | | | BET | | |
|---|---|---|---|---|---|
| positive | | Average | specific | Solid- | |
| electrode | | particle | surface | liquid | |
| active | NCM | size | area | ratio | First |
| material | ratio | D50 (μm) | (m²/g) | (mass %) | pH |
| A | 82/13/5 | 3.7 | 0.55 | 40 | 12.0 |
| B | 82/13/5 | 3.7 | 0.55 | No rinsing | 12.7 |
| C | 82/13/5 | 3.7 | 0.55 | 20 | 11.6 |
| D | 92/4/4 | 17.1 | 0.66 | 40 | 12.3 |
| E | 70/10/20 | 4.1 | 0.53 | No rinsing | 11.9 |
| F | 60/20/20 | 4.2 | 0.54 | No rinsing | 11.7 |
| G | 96/2/2 | 16.7 | 0.58 | 40 | 12.7 |

### Test Example 1

Positive electrode active material A, acetylene black (AB) as a conductive material, and polyvinylidene difluoride (PVDF) as a binder were mixed together in a mass ratio of (positive electrode active material A):AB:PVDF=97.5:1.5:1.0, and to the resulting mixture, a proper amount of N-methyl-2-pyrrolidone (NMP) was added, to prepare a positive electrode composite material slurry. The resulting positive electrode composite material slurry was applied to both sides of a positive electrode current collector made of an Al foil sheet, followed by drying, and thereby a positive electrode composite material layer was formed. The positive electrode composite material layer was roll pressed with a roller and then cut into certain dimensions, and thereby a positive electrode plate of Test Example 1 was prepared.

### Test Example 2

Positive electrode active material A, N-methyl-2-pyrrolidone (NMP), and polyvinylidene difluoride (PVDF) as a binder were mixed together, and to the resulting mixed solution, acetylene black (AB) as a conductive material and an additive containing a heterocyclic-ring-containing compound were added and mixed in a mass ratio of (positive electrode active material A):AB:PVDF:(heterocyclic-ring-containing compound)=97.495:1.5:1.0:0.005, and thereby a positive electrode composite material slurry was prepared. As the additive containing a heterocyclic-ring-containing compound, an N-methylpyrrolidone solution (“SA-426H” manufactured by Nissan Chemical Corporation) containing a heterocyclic-ring-containing compound represented by the formula (1) or the formula (2) in a ratio of 35 mass % was used. The positive electrode composite material slurry was applied to both sides of a positive electrode current collector made of an Al foil sheet, followed by drying, and thereby a positive electrode composite material layer was formed. The positive electrode composite material layer was roll pressed with a roller and then cut into certain dimensions, and thereby a positive electrode plate of Test Example 2 was prepared.

### Test Examples 3 to 10

Positive electrode plates were prepared in the same manner as in Test Example 2 except that the amount of the additive was changed as specified in Table 2.

### Test Examples 11 to 18

Positive electrode plates were prepared in the same manner as in Test Example 2 except that the type of the positive electrode active material and the amount of the additive were changed as specified in Table 2.

### [Preparation of Evaluation-Purpose Lithium-Ion Secondary Battery]

Graphite (C) as a negative electrode active material, styrene-butadiene rubber (SBR) as a binder, and carboxymethylcellulose (CMC) as a thickener were mixed in a mass ratio of C:SBR:CMC-98:1:1 in ion-exchanged water to prepare a negative electrode composite material slurry. The resulting negative electrode composite material slurry was applied to a copper foil sheet, followed by drying, and thereby a negative electrode composite material layer was formed. The negative electrode composite material layer was roll pressed with a roller to a certain density and then cut into certain dimensions, and thereby a negative electrode plate was prepared.

As a separator, a porous polyolefin sheet was prepared. The positive electrode plate of each Test Example and the negative electrode plate were stacked together with the separator interposed between them, and thereby a stack-type electrode assembly was prepared.

An electrode terminal was attached to the stack-type electrode assembly, and the resultant was inserted into a battery case made of an aluminum laminated sheet, followed by injection of a non-aqueous electrolyte. The non-aqueous electrolyte was prepared by dissolving LiPF₆ as a supporting salt (in a concentration of 1 mol/L) in a mixed solvent containing ethylene carbonate (EC) and ethyl methyl carbonate (EMC) in a volume ratio of EC:EMC:DMC-30:70, and adding vinylene carbonate thereto at 0.3 mass %. Subsequently, the battery case was sealed, and thereby an evaluation-purpose lithium-ion secondary battery was obtained.

### [Evaluation of Charged Capacity]

The evaluation-purpose lithium-ion secondary battery was subjected to constant-current charging under conditions at a temperature of 25° C. at a current density of 0.2 mA/cm² to reach an electric potential of 4.3 V vs. Li/Li+, followed by constant-voltage charging at an electric potential of 4.3 V vs. Li/Li+ to reach a current density of 0.04 mA/cm², and the charged capacity [mAh/g] per unit mass of the positive electrode active material was measured. Results are given in Table 2.

### [Evaluation of Output Resistance]

The output resistance at the time when the state of charge (SOC) of the evaluation-purpose lithium-ion secondary battery was 50% (namely, when the charged capacity relative to the initial discharged capacity was 50%) was measured at 25° C. Results are given in Table 2. Output resistance was rated as follows: “Insufficient” when the value of output resistance was 0.090Ω or more; “Fair” when it was less than 0.090Ω and not less than 0.080Ω; and “Good” when it was less than 0.080Ω.

TABLE 2

| | | Content of | | | |
|---|---|---|---|---|---|
| | | hetero- | Output resistance | | |
| | Type of | cyclic- | Output | | |
| | positive | ring- | resis- | | |
| | electrode | containing | tance | | Charged |
| Test | active | compound | value | | capacity |
| Example | material | (mass %) | (Ω) | Rating | (mAh/g) |
| 1 | A | None | 0.095 | Insufficient | 224 |
| 2 | A | 0.005 | 0.091 | Insufficient | 223 |
| 3 | A | 0.0125 | 0.088 | Fair | 224 |
| 4 | A | 0.025 | 0.079 | Good | 224 |
| 5 | A | 0.05 | 0.076 | Good | 224 |
| 6 | A | 0.1 | 0.074 | Good | 225 |
| 7 | A | 0.2 | 0.078 | Good | 224 |
| 8 | A | 0.3 | 0.081 | Fair | 223 |
| 9 | A | 0.5 | 0.087 | Fair | 221 |
| 10 | A | 1.0 | 0.098 | Insufficient | 217 |
| 11 | B | 0.5 | 0.097 | Insufficient | 221 |
| 12 | C | None | 0.078 | Good | 215 |
| 13 | D | None | 0.098 | Insufficient | 244 |
| 14 | D | 0.2 | 0.076 | Good | 242 |
| 15 | E | None | 0.091 | Insufficient | 211 |
| 16 | E | 0.2 | 0.077 | Good | 212 |
| 17 | F | None | 0.073 | Good | 203 |
| 18 | G | 0.2 | 0.095 | Insufficient | 253 |

In Test Examples 3 to 9, 14, 16, and 17 where a heterocyclic-ring-containing compound was included in a certain content and a positive electrode active material of a certain first pH was included, output resistance was good and a decrease of charged capacity was inhibited. In contrast to this, in Test Example 1 where no heterocyclic-ring-containing compound was included, the positive electrode current collector (Al foil sheet) corroded and output resistance increased. Moreover, in Test Example 2, due to the low content of the heterocyclic-ring-containing compound, output resistance increased. On the other hand, in Test Example 10, due to the high content of the heterocyclic-ring-containing compound, output resistance increased and charged capacity decreased.

In Test Example 11 where a heterocyclic-ring-containing compound was included in a certain content but the first pH of the positive electrode active material was too high, the positive electrode current collector (Al foil sheet) corroded and output resistance increased. In Test Example 12 where rinsing conditions were too severe and thereby the first pH was too low, the positive electrode current collector tended not to corrode and thereby an increase of output resistance was inhibited, but due to the excessively low content of alkaline components, charged capacity decreased.

In Test Example 13 where no heterocyclic-ring-containing compound was included, the positive electrode current collector (Al foil sheet) corroded and output resistance increased. In Test Example 14 where the same positive electrode active material as in Test Example 13 was included, output resistance was good due to a heterocyclic-ring-containing compound included in a certain content, and a decrease of charged capacity was inhibited.

In Test Example 15 where the first pH was within a certain range but no heterocyclic-ring-containing compound was included, the positive electrode current collector (Al foil sheet) corroded and output resistance increased. In Test Example 16 where the same positive electrode active material as in Test Example 15 was included, output resistance was good due to a heterocyclic-ring-containing compound included in a certain content, and a decrease of charged capacity was inhibited.

In Test Example 17, due to the low Ni content, corrosion of the positive electrode current collector (Al foil sheet) tended not to occur and thereby output resistance did not increase, but charged capacity decreased. In Test Example 18 where a heterocyclic-ring-containing compound was included in a certain content but the first pH was high, the positive electrode current collector (Al foil sheet) corroded and output resistance increased.

Although the embodiments of the present invention have been described, the embodiments disclosed herein are illustrative and non-restrictive in any respect. The scope of the present invention is defined by the terms of the claims, and is intended to encompass any modifications within the meaning and the scope equivalent to the terms of the claims.

What is claimed is:

1. A positive electrode plate for a non-aqueous electrolyte secondary battery, the positive electrode plate comprising:
a positive electrode composite material layer; and
a positive electrode current collector, wherein
the positive electrode current collector contains aluminum,
the positive electrode composite material layer includes a positive electrode active material and at least one type of heterocyclic-ring-containing compound represented by a formula (1) below: 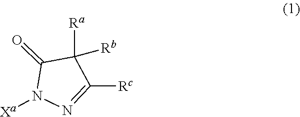
where
R^{a} to R^{c} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group, or
a formula (2) below: 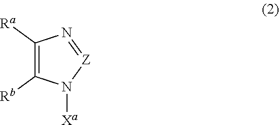
where
R^{a} and R^{b} are independently a hydrogen atom, a halogen atom, a carboxy group, a hydroxy group, a thiol group, an amino group, an optionally-substituted C₁₋₆ alkyl group, an optionally-substituted C₂₋₆ alkenyl group, or an optionally-substituted C₆₋₁₂ aryl group;
R^{a} and R^{b} are optionally bonded together to form an optionally-substituted C₄₋₁₂ ring;
Z is N or C—R^{d};
R^{d} is a hydrogen atom, a halogen atom, a carboxy group, a hydroxy group, a thiol group, an optionally-substituted C₁₋₆ alkyl group, an optionally-substituted C₂₋₆ alkenyl group, or an optionally-substituted C₆₋₁₂ aryl group; and
X^{a} is a hydrogen atom, an optionally-substituted C₁₋₆ alkyl group, or an optionally-substituted C₆₋₁₂ aryl group,
the positive electrode active material is a lithium-(transition metal) composite oxide that contains lithium and nickel,
a content of nickel in the lithium-(transition metal) composite oxide is 70 mol % or more relative to a total number of moles of metallic element except lithium,
a pH of the positive electrode active material in a state of a filtrate obtained by adding 25 g of the positive electrode active material to 50 g of pure water followed by stirring for 5 minutes and filtration is from 11.8 to 12.5, and
a content of the heterocyclic-ring-containing compound in the positive electrode composite material layer is from 0.01 to 0.5 mass % relative to a mass of the positive electrode composite material layer.

2. The positive electrode plate for a non-aqueous electrolyte secondary battery according to claim 1, wherein the positive electrode active material includes a first active material having an average particle size D50 from 2 to 6 μm.

3. The positive electrode plate for a non-aqueous electrolyte secondary battery according to claim 2, wherein the first active material is in a form of single particles, or in a form of secondary particles each consisting of 2 to 10 primary particles aggregated together.

4. The positive electrode plate for a non-aqueous electrolyte secondary battery according to claim 2, wherein the first active material has a BET specific surface area from 0.2 to 1.5 m²/g.

5. The positive electrode plate for a non-aqueous electrolyte secondary battery according to claim 1, wherein the positive electrode active material includes a second active material having an average particle size D50 from 10 to 20 μm.

6. The positive electrode plate for a non-aqueous electrolyte secondary battery according to claim 5, wherein the second active material is in a form of secondary particles each consisting of 50 or more primary particles aggregated together.

7. The positive electrode plate for a non-aqueous electrolyte secondary battery according to claim 5, wherein the second active material has a BET specific surface area from 0.2 to 1.0 m²/g.

8. A method of producing a positive electrode plate for a non-aqueous electrolyte secondary battery, wherein
the method is a method of producing the positive electrode plate for a non-aqueous electrolyte secondary battery according to claim 1, and
the method includes a slurry preparation step that involves mixing the positive electrode active material and the heterocyclic-ring-containing compound together to obtain a positive electrode composite material slurry.

9. The method of producing a positive electrode plate for a non-aqueous electrolyte secondary battery according to claim 8, wherein the slurry preparation step includes:
a first step to mix the positive electrode active material, a binder, and a dispersion medium to obtain a first mixture; and
a second step to mix the first mixture and the heterocyclic-ring-containing compound to obtain a second mixture.

10. The method of producing a positive electrode plate for a non-aqueous electrolyte secondary battery according to claim 8, wherein the positive electrode active material and the heterocyclic-ring-containing compound are mixed so that a content of the heterocyclic-ring-containing compound relative to a solid matter in the positive electrode composite material slurry becomes 0.01 to 0.5 mass %.

11. A non-aqueous electrolyte secondary battery comprising the positive electrode plate for a non-aqueous electrolyte secondary battery according to claim 1.
